(19) United States
(12) Patent Application Publication
(10) Pub. No.: US 2002/0072858 A1
(43) Pub. Date: Jun. 13, 2002

(54) Method of periodically or constantly watching a person's blood sugar and system thereof

(75) Inventor: Hui-Wen Cheng, Taipei (TW)

Correspondence Address: BACON & THOMAS, 625 Slaters Lane - 4th Floor, Alexandria, VA, 22314, US

(73) Assignee: TrustMed.Com Corp., Taipei (TW)

(21) Appl. No.: 09/781,969

(22) Filed: Feb. 14, 2001

(30) Foreign Application Priority Data
Oct. 31, 2000 (TW) 89122930

(51) Int. Cl. G06F 19/00

(52) U.S. Cl. 702/19; 702/22

(57) ABSTRACT

A system of watching a person's blood sugar includes a database server; a network server; and a communication devices; wherein the database server is built-in with a database of blood sugar and with a software, so that a) the database server determines time for a person to measure his/her blood sugar according to medical criteria on his/her blood sugar history recorded in the database; b) the network server and the communication device notify the person to measure his/her blood sugar in advance the determined time and report his/her measured blood sugar to the network server according to the determined time; and c) the network server and the communication device remind the person of the blood sugar measurement if the network server should fail to receive his/her measured blood sugar after the determined time.

### FIELD OF THE INVENTION

The present invention relates to a method and a system of periodically or constantly watching a person's blood sugar.

### BACKGROUND OF THE INVENTION

After receiving a treatment from a doctor, a diabetic patient should continue his/her treatment according to the appointment with the doctor. However, due to lack of an adequate reminding system, the hospital is unable to remind a patient of the appointment in advance or after the patient misses the appointment. Therefore, a diabetic patient suffers a higher risk of seizure, myocardial infarction, blindness, renal failure, etc.

### SUMMARY OF THE INVENTION

The present invention provides a method and a system of periodically or constantly recording and watching a patient's blood sugar to solve the above-mentioned problems long existed in the medical field.

In one aspect of the present invention, a method of periodically or constantly recording and watching a patient's blood sugar according to the present invention is carried out via a network.

In another aspect of the present invention, a system of periodically or constantly recording and watching a patient's blood sugar according to the present invention works cooperatively with a network.

### BRIEF DESCRIPTION OF THE DRAWINGS

FIG. 1 is a flowchart showing a method of periodically or constantly recording and watching a patient's blood sugar according to a first embodiment of the present invention.

FIG. 2 is a schematic block diagram showing a system of periodically or constantly recording and watching a patient's blood sugar according to the present invention.

FIG. 3 is a flowchart showing a method of periodically or constantly recording and watching a patient's blood sugar according to a second embodiment of the present invention.

### DETAILED DESCRIPTION OF THE INVENTION

The present invention discloses a method of periodically or constantly watching a person's blood sugar comprising the following steps carried out in a computer system:

a) determining time for a person to measure his/her blood sugar according to medical criteria on his/her blood sugar history recorded in a database of blood sugar of persons;

b) notifying said person to measure his/her blood sugar and report his/her measured blood sugar to said computer system in advance the determined time;

c) reminding said person of the blood sugar measurement if said computer system should fail to receive his/her measured blood sugar after the determined time; and

d) entering the measured data of blood sugar of said person into the database of blood sugar of persons, if said computer system receives his/her measured blood sugar.

Preferably, said medical criteria are once every month.

Preferably, said reminding is once per day.

Preferably, said notifying or said reminding step adopt a WAP system.

The database of blood sugar is preferably set up before the method of the present invention is implemented; however, it can also be set up when the method of the present invention is initiated.

The database of blood sugar contains data of a diabetic or a potential diabetic patient that should be recorded by a medical practitioner, e.g. name (or ID number, such as citizen's ID number, number of registration card of a hospital), data of blood sugar, etc., preferably may include further detailed information of the patient, e.g. habits of living, risk factors that might cause diabetes, etc.

The medical criteria for determining the time for a patient to measure his/her blood sugar can be a doctor's subjective judgement or according to the general regulation of once per month for a diabetic patient.

A diagnostic standard proposed by the American Diabetes Association: a diabetes exists when the blood sugar exceeds 126 mg/100 ml on an empty stomach, and the value is normal when the blood sugar is below 110 mg/100 ml on an empty stomach.

The diagnostic of blood sugar can be carried out according to the subjective judgement by a doctor, or from a specific checklist (as shown in Table 1).

TABLE 1

| | Unit | Normal | Acceptable | Poor |
|---|---|---|---|---|
| Blood sugar before meal | mg/100 ml | 70-110 | ≦140 | >140 |
| (about 30 minutes before | | | | |
| meal) | | | | |
| Blood sugar after meal | mg/100 ml | 70-140 | ≦180 | >180 |
| (about 2 hours after | | | | |
| meal) | | | | |

The above-mentioned notification or reminder can be carried out by using any known methods of notification or reminder, such as notification/reminder by a conventional telephone, notification/reminder through a network (e.g. e-mail, mobile phone, cable telephone, etc.) Preferably, the notification/reminder is carried out through a network. More preferably, the notification/reminder is carried out by using a mobile phone through a network. Most preferably, the notification/reminder is carried out by a mobile phone system using WAP (Wireless Application Protocol).

The abovementioned reminder is based on whether a diabetic patient has reported the measured blood sugar within a certain period of time after receiving a notification (or a previous reminder). Of course, the number of times of reminding can also be set to a default value, e.g. stop reminding, when no response from the patient is received after a specified number of reminders.

Other data related to blood sugar, e.g. change of lifestyle of a diabetic patient and other history of related diseases, can also be simultaneously recorded in the database.

The term “in advance” varies according to the need. For example, a patient reserving a clinical visit requires only slightly earlier (a few days or even earlier that day); a patient without a reservation requires a much earlier notification for the patient to register or make a reservation.

The present invention also discloses a system of watching a person's blood sugar comprising:

a database server;

a network server; and

communication means;

wherein said database server is built-in with a database of blood sugar and with a software, so that

A) said database server determines time for a person to measure his/her blood sugar according to medical criteria on his/her blood sugar history recorded in said database;

B) said network server and said communication means notify said person to measure his/her blood sugar in advance the determined time and report his/her measured blood sugar to said network server according to the determined time; and

C) said network server and said communication means remind said person of the blood sugar measurement if said network server should fail to receive his/her measured blood sugar after the determined time.

The database server used in the system of the present invention can be any known database servers.

The network server can be any known network servers, and said communication means can adopt any known communication means, preferably wireless communication means, more preferably a WAP system.

Said determination can be a regular determination or a random determination. Preferably, the determination is carried out after each recordal of new measurement of blood sugar in order to save the time spent on the determination.

The content of notification can be a simple date of measurement of blood sugar, or can be added with other contents, such as common sense/knowledge/information related to blood sugar measurement or control of diabetes, etc.

The method and the system of periodically or constantly recording and watching blood sugar according to the present invention is not limited to be used by a hospital, and can be used by a medical research organization or an organization in the medical profession having a power of public reputation, and/or a subsidiary thereof.

In order to further elaborate the present invention, preferred embodiments are illustrated together with figures. However, the scope of the present invention is not limited by the preferred embodiments or figures.

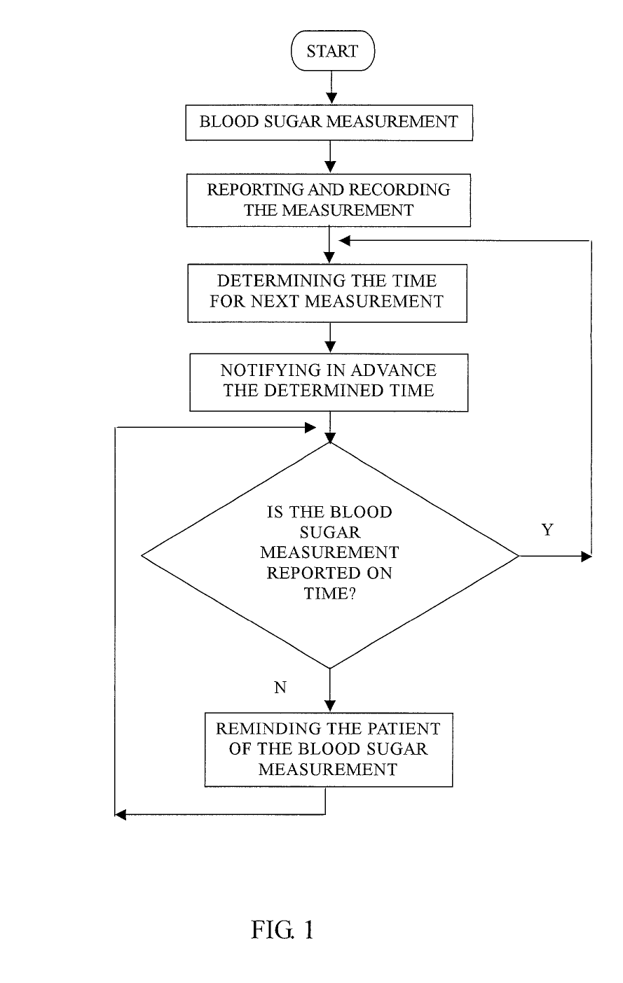

FIG. 1 is a schematic flowchart of a method of periodically recording and watching blood sugar implemented in a hospital. The method comprises measuring a patient's the blood sugar; reporting and recording the measured blood sugar; determining the time for next measurement; notifying the patient in advance the determined time; checking whether the patient reports his/her blood sugar according to the determined time; reminding the patient of the blood sugar measurement, if the answer is “No”, and returning to the step of determining the time for next measurement, if the answer is “Yes”.

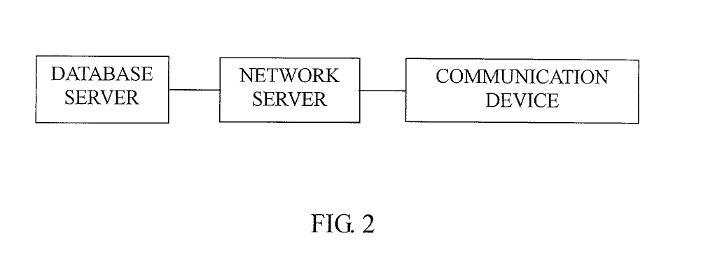

FIG. 2 is a block diagram of a system of periodically recording and watching blood sugar for use in a hospital, in which the database server uses a computer and a UNIX system, the network server uses a computer and a UNIX system, and the communication device uses a WAP system. The database server and the communication device are connected to the network server.

A new patient only needs to enter the required data to the database of blood sugar before, after or at the time of measuring the blood sugar.

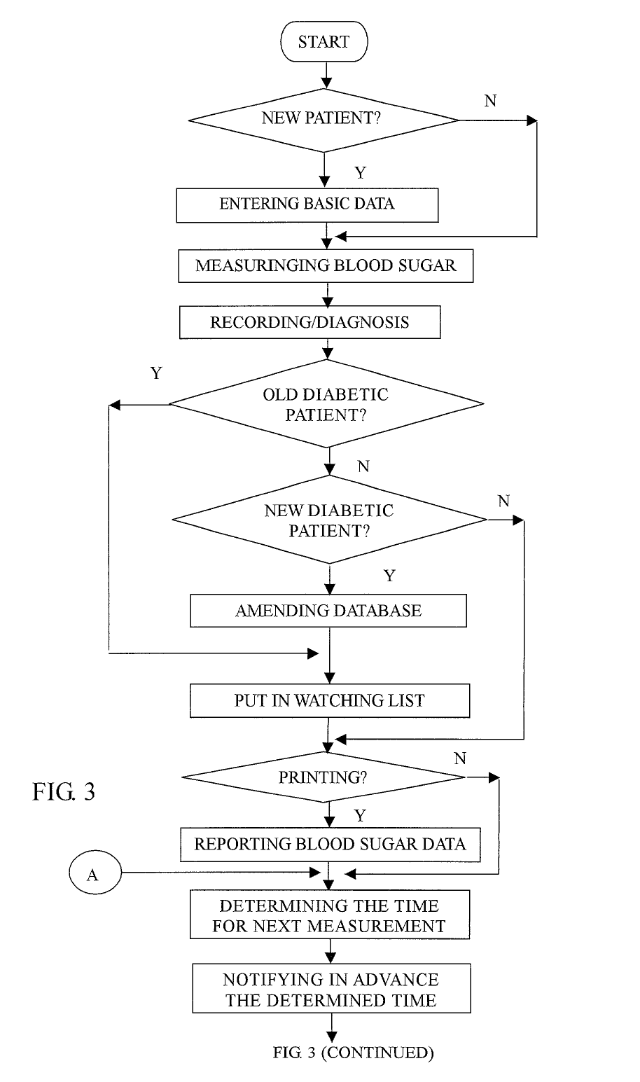

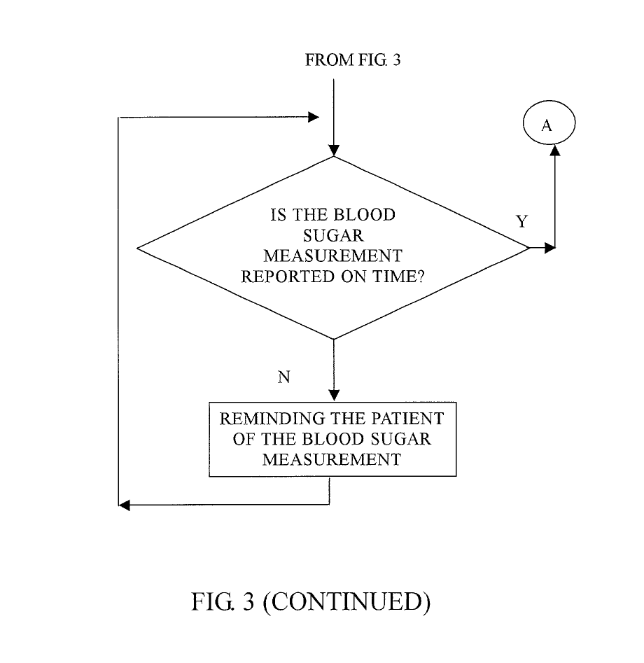

In another embodiment, the method of the present invention includes setting up the database for new patients. As shown in FIG. 3, the method of this embodiment is similar to that shown in FIG. 1, with the addition of three determination formulas: “whether this is a new client (patient)?”, “whether this is an old diabetic patient?”, and “whether this is a new diabetic patient?”. The method according to this embodiment first decides whether a person taking a blood sugar measurement is a new client (patient) or not. A new patient is required to enter the basic data before the measurement. The blood sugar measurement is then recorded and is used for diagnosis. The status of the client will be checked to decide whether the client is an old diabetic patient or not. If the client is not an old diabetic patient, he/she will be decided as a new diabetic patient or not based on the blood sugar data. If the answer is “Yes”, the status of the client will be changed to a diabetic patient and put into the watching list. If the answer is “No”, the client will not be put into the watching list. If the client is an old diabetic patient, he/she will be put in the watching list directly. The method will then decide whether the blood sugar data of the client is to be printed, so that the client can receive the printing report which may include the historical data of blood sugar, the trend diagram of blood sugar, etc. The steps thereafter are same as those shown in FIG. 1.

What is claimed is:

1. A method of periodically or constantly watching a person's blood sugar comprising the following steps carried out in a computer system:
a) determining time for a person to measure his/her blood sugar according to medical criteria on his/her blood sugar history recorded in a database of blood sugar of persons;
b) notifying said person to measure his/her blood sugar and report his/her measured blood sugar to said computer system in advance the determined time;
c) reminding said person of the blood sugar measurement if said computer system should fail to receive his/her measured blood sugar after the determined time; and
d) entering the measured data of blood sugar of said person into the database of blood sugar of persons, if said computer system receives his/her measured blood sugar.

2. The method as claimed in claim 1, in which said medical criteria in step a) are once every month.

3. The method as claimed in claim 1, in which said reminding is once per day.

4. The method as claimed in claim 1, in which said notifying or said reminding step adopt a WAP system.

5. A system of watching a person's blood sugar comprising:
a database server;
a network server; and
communication means;
wherein said database server is built-in with a database of blood sugar and with a software, so that
a) said database server determines time for a person to measure his/her blood sugar according to medical criteria on his/her blood sugar history recorded in said database;
b) said network server and said communication means notify said person to measure his/her blood sugar in advance the determined time and report his/her measured blood sugar to said network server according to the determined time; and
c) said network server and said communication means remind said person of the blood sugar measurement if said network server should fail to receive his/her measured blood sugar after the determined time.

6. The system as claimed in claim 5, in which said medical criteria are once every month.

7. The system as claimed in claim 5, in which said communication means comprises a WAP system.
